(19) United States
(12) Patent Application Publication
(10) Pub. No.: US 2005/0091426 A1
(43) Pub. Date: Apr. 28, 2005

(54) Optimized port selection for command completion in a multi-ported storage controller system

(76) Inventors: Robert L. Horn, Yorba Linda, CA (US); Virgil V. Wilkins, Perris, CA (US)

Correspondence Address: DICKSTEIN SHAPIRO MORIN & OSHINSKY LLP, 2101 L Street, NW, Washington, DC, 20037, US

(21) Appl. No.: 10/854,226

(22) Filed: May 27, 2004

Related U.S. Application Data
(60) Provisional application No. 60/513,208, filed on Oct. 23, 2003.

(51) Int. Cl. G06F 3/00

(52) U.S. Cl. 710/33

(57) ABSTRACT

A multi-ported storage area network (SAN) controller system with command completion that utilizes optimal port selection. The system determines the optimal port for command completion based on criteria such as loop bandwidth utilization or port throughput maximization, and allows data and response information to occur via the optimal port regardless of the receiving port. This is accomplished through port aliasing (spoofing) of port identities, in which the receiving port identity is substituted into a sending port identity by a distributed control entity. In this way, any port within the SAN may return data or status to the originating host.

This application claims the benefit of U.S. Provisional Application Ser. No. 60/513,208, filed on Oct. 23, 2003.

### BACKGROUND OF THE INVENTION

1. Field of the Invention

The present invention relates to a networked storage system. In particular, this invention relates to a storage area network with optimal port selection and, more specifically, a multi-ported storage controller system with command completion via optimized port selection.

2. Description of the Related Art

With the rapidly accelerating growth of Internet and intranet communication, high-bandwidth applications (such as streaming video), and large information databases, the need for networked storage systems has increased dramatically. Of particular concern is the performance level of networked storage, especially in high-utilization and high-bandwidth use models. A key determinant in the performance of a networked storage system is the function of optimizing data paths within the storage network.

In a networked storage system, users access volumes on the networked storage system through host ports. The host ports may be located in close proximity to the actual storage elements, or they may be several miles away. The timely transfer of commands and data between the host ports and storage elements is critical to maximizing system performance. A key determinant in that performance metric is the path the commands and data take between the storage element and the host port. In a typical networked storage system, individual storage elements are managed by storage controllers that provide ports that interface to the storage network fabric. The storage network fabric, in turn, provides the communication path to the host ports. In conventional networked storage systems, the storage controller port that receives a command from a host port must be the storage controller port that returns any data or command status information. However, in many multi-controller, multi-ported systems, the controller element that receives a command from a host port may not be the optimal (or most efficient) controller to return a response to the host port. Unfortunately, conventional systems have no way of determining which port in a networked storage system is the optimal port for command response. This limitation can result in port load imbalances, sub-optimal bandwidth usage, and overall system performance degradation.

Attempts have been made to improve performance in similar systems, such as that described in the following patent. U.S. Pat. No. 6,170,023, “System for accessing an input/output device using multiple addresses,” describes a system for performing input/output (I/O) operations with a processing unit. A processing unit, such as a host system, determines a base and associated alias addresses to address an I/O device, such as a disk or direct access storage device (DASD). The processing unit associates the determined base and alias addresses to the I/O device. The association of base and alias addresses is maintained constant for subsequent I/O operations until the processing unit detects a reassignment of the association of base and alias addresses. The processing unit then determines an available base or alias address to use with an I/O operation and may concurrently execute multiple I/O operations against the I/O device using the base and alias addresses.

Although the system disclosed in the '023 patent helps to improve system performance by providing a means of aliasing for I/O, that system does not offer an architecture that allows the determination of the optimal controller element port for data and status return to the host port.

Therefore, it is an object of the present invention to provide a multi-ported storage controller system able to determine the optimal port for command completion.

It is another object of this invention to provide a multi-ported storage controller system able to utilize the optimal port for command completion.

It is yet another object of this invention to provide a multi-ported storage controller system able to most efficiently utilize system bandwidth.

It is yet another object of this invention to provide a multi-ported storage controller system able to maximize port throughput.

It is yet another object of this invention to provide a multi-ported storage controller system able to maximize overall system performance.

### SUMMARY OF THE INVENTION

The present invention is a multi-ported storage area network (SAN) controller system with command completion that utilizes optimal port selection. The system determines the optimal port for command completion based on criteria such as loop bandwidth utilization or port throughput maximization, and allows data and response information to be routed via the optimal port regardless of the receiving port. This is accomplished through port aliasing (i.e., spoofing) of port identities, in which the receiving port identity is substituted into a sending port identity by a distributed control entity. In this way, any port within the SAN may return data or status to the originating host.

### BRIEF DESCRIPTION OF THE DRAWINGS

The foregoing and other advantages and features of the invention will become more apparent from the detailed description of exemplary embodiments of the invention given below with reference to the accompanying drawings, in which:

FIG. 1 illustrates a networked storage system architecture;

FIG. 2 is a flow diagram of a conventional command completion method; and

FIG. 3 is a flow diagram of a command completion method using optimized port selection.

### DETAILED DESCRIPTION OF THE PREFERRED EMBODIMENT

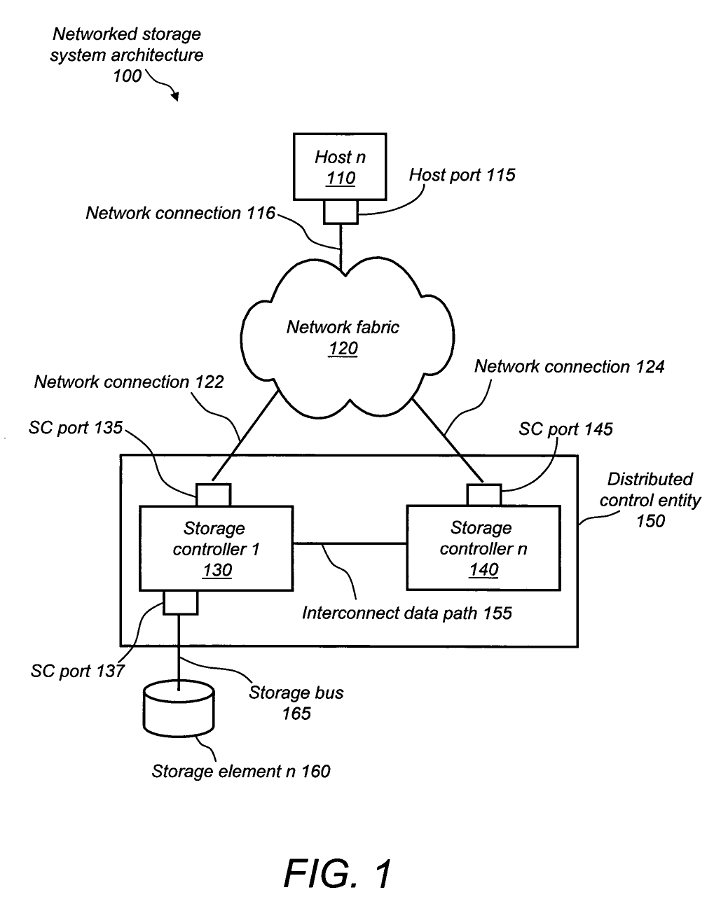

Now referring to the drawings, where like reference numerals designate like elements, there is shown in FIG. 1 a networked storage system architecture 100 that includes a host n 110, a network fabric 120, a storage controller 1 130, a storage controller n 140, a distributed control entity 150, and a storage element n 160. In general, “n” is used herein to indicate an indefinite plurality, so that the number “n” when referred to one component does not necessarily equal the number “n” of a different component. Networked storage system architecture 100 also includes a storage bus 165, an SC port 135, an SC port 137, a network connection 122, a network connection 116, a host port 115, an SC port 145, a network connection 124, and an interconnect data path 155. Network fabric 120 is a dedicated network topology for storage access consisting of any of a number of connection schemes as required for the specific application and geographical location relative to elements of the storage area network. Storage controller 1 130 and storage controller n 140 are enterprise-class controllers capable of interconnecting with multiple hosts and controlling large disk arrays.

The configuration shown in networked storage system architecture 100 may include any number of hosts, any number of controllers, and any number of interconnects. For simplicity and ease of explanation, only a representative sample of each is shown. In a topology with multiple interconnects, path load balancing algorithms generally determine which interconnect is used. Path load balancing is fully disclosed in U.S. patent application Ser. No. 10/637,533, entitled “Method of Providing Asymmetrical Load Balancing to Mirrored Elements of a Storage Volume”, and is hereby incorporated by reference.

The information provided by distributed control entity 150 may be obtained by storage controller 1 130 and storage controller n 140 from host n 110 or from another device connected to network fabric 120.

Distributed control entity 150 provides information required by the storage controllers to perform command completion and port optimization. Distributed control entity 150 may be resident on one or more storage controllers or on external hardware (not shown). Distributed control entity 150 may be interconnected with storage controller 1 130 through storage controller n 140 by network fabric 120, as well as by interconnect data path 155 or a separate back-end loop (not shown).

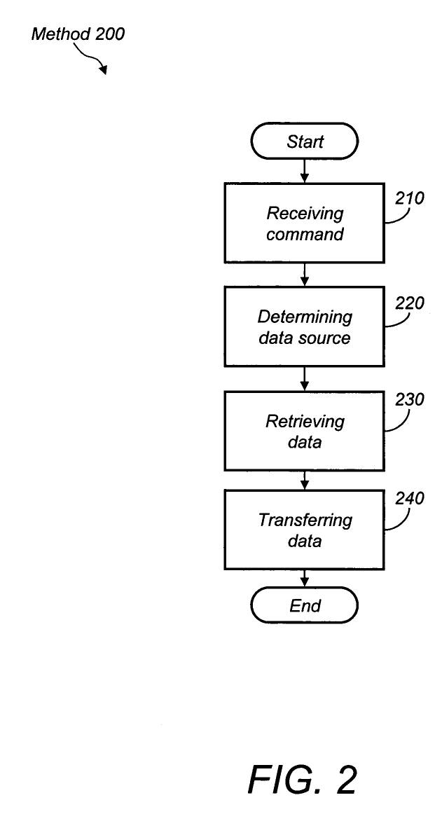

In one example of conventional command completion, host n 110 issues a read request for a volume resident on storage element n 160. Host n 110 forwards the read request to storage controller n 140 via network fabric 120 and SC port 145. Storage controller n 140 knows that storage controller 1 130 controls storage element n 160 from volume mapping information supplied by distributed control entity 150. Storage controller n 140 forwards the read request via interconnect data path 155 to storage controller 1 130, where the read from storage element n 160 is completed. In conventional operation, host port 115 expects that SC port 145 will return the data and status, and will only accept such data and status from a port identifying itself as SC port 145. In this conventional case, storage controller 1 130 forwards the data and status to storage controller n 140. Storage controller n 140 then forwards the read complete data and status back to host n 110 via SC port 145 and deletes the original stored command. This operation is explained in detail in connection with FIG. 2.

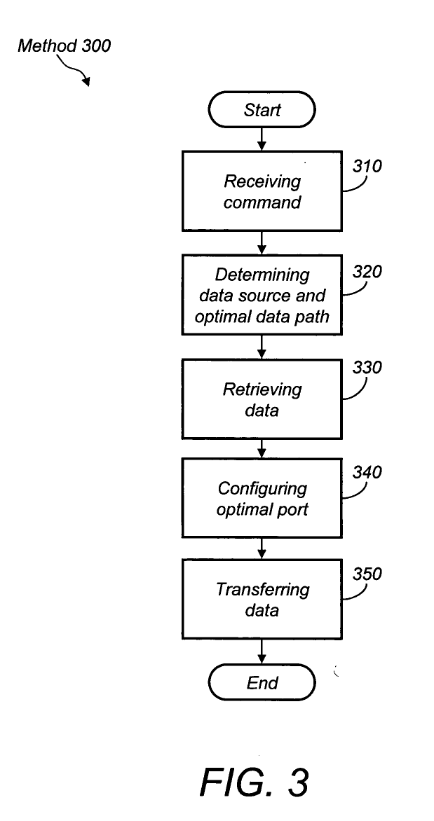

In one example of command completion utilizing port optimization, host n 110 issues a read request for a volume resident on storage element n 160. Host n 110 forwards the read request to storage controller n 140 via network fabric 120 and SC port 145. Storage controller n 140 knows that storage controller 1 130 controls storage element n 160 from volume mapping information supplied by distributed control entity 150 and forwards the read request via interconnect data path 155 to storage controller 1 130, where the read from storage element n 160 is completed. Using dynamic and/or static configuration criteria, such as port throughput maximization, distributed control entity 150 determines that SC port 135 is the optimal port for returning read complete data and status to host n 110. Distributed control entity 150 configures SC port 135 to behave as if it were SC port 145 (i.e., to “spoof” SC port 145) by substituting the port identifier of SC port 145 into the data and response frame of SC port 135. Host n 110 will now accept data and status from SC port 135 as if it had originated from SC port 145. Storage controller 1 130 forwards the read complete data and status to host n 110 via SC port 135 and deletes the original stored command. This operation is explained in detail in connection with FIG. 3.

FIG. 2 is a flow diagram of a method 200 for conventional command completion, as described above. In this example, host n 110 requests a read action to storage controller n 140 via SC port 145.

Step 210: Receiving Command

In this step, SC port 145 receives a read action request from host n 110. The request is routed through host port 115, network connection 116, network fabric 120, and network connection 124 to SC port 145 of storage controller n 140. Method 200 proceeds to step 220.

Step 220: Determining Data Source

In this step, distributed control entity 150 determines the data source necessary to complete the read request. In this example, storage element n 160 is the data source. Distributed control entity 150 further determines that storage element n 160 is controlled by storage controller 1 130. Method 200 proceeds to step 230.

Step 230: Retrieving Data

In this step, storage controller n 140 forwards the read action request to storage controller 1 130 via interconnect data path 155. Storage controller 1 130 retrieves the requested data from storage element n 160 via storage bus 165 and SC port 137. Method 200 proceeds to step 240.

Step 240: Transferring Data

In this step, distributed control entity 150 transfers the data and status retrieved in step 230 from storage controller 1 130 to storage controller n 140 via interconnect data path 155. Storage controller n 140 transmits the data to host n 110 via SC port 145, network connection 124, network fabric 120, network connection 116, and host port 115. Method 200 ends.

FIG. 3 is a flow diagram of a method 300 for command completion using optimized port selection in accordance with the present invention and as described above. In this example, host n 110 requests a read action to storage controller n 140 via SC port 145.

Step 310: Receiving Command

In this step, SC port 145 receives a read action request from host n 110 and host port 115. The request is routed through network connection 116, network fabric 120, and network connection 124 to SC port 145 of storage controller n 140. Method 300 proceeds to step 320.

Step 320: Determining Data Source And Optimal Data Path

In this step, distributed control entity 150 determines the data source necessary to complete the request and the optimal path for data transfer to host n 110. In this example, storage element n 160 is the data source. Distributed control entity 150 further determines that storage element n 160 is controlled by storage controller 1 130. In this example, distributed control entity 150 further determines that the optimal data path is through SC port 135. Different embodiments of the present invention may use different criteria, or different combinations of criteria to determine the optimal data path. Some embodiments may use at least one of the following factors to determine the optimal path: storage controller to storage element association (physical or logical connection), loop bandwidth utilization, port throughput maximization, or path load balancing. Method 300 proceeds to step 330.

Step 330: Retrieving Data

In this step, storage controller n 140 forwards the read action request to storage controller 1 130 via interconnect data path 155 and retrieves the requested data from storage element n 160 via storage bus 165. Method 300 proceeds to step 340.

Step 340: Configuring Optimal Port

In this step, distributed control entity 150 configures SC port 135 to behave as if it were SC port 145 (i.e., SC port 135 “spoofs” SC port 145) to allow the transfer of data to host n 110 via SC port 135. In one embodiment, distributed control entity 150 substitutes the ID of the receiver port (SC port 145) into the data and response frame(s) of the ID of the sending port (SC port 135).

For example, the data and response frame of SC port 145 may contain the following information: originator exchange ID (OXID)=1, responder exchange ID (RXID)=3, and Port ID=Y. After distributed control entity 150 determines that SC port 135 is the optimal port for data transfer to host n 110, distributed control entity 150 substitutes the ID information of SC port 145 into the data and response frame of SC port 135. Therefore, the data and response frame of SC port 135 includes the same information as that of SC port 145: OXID=1, RXID=3, and Port ID=Y. Host n 110 is then unable to distinguish between data originating from SC port 145 and data originating from SC port 135. Method 300 proceeds to step 350.

Step 350: Transferring Data

In this step, distributed control entity 150 transfers the data and status retrieved in step 330 to host n 110 via SC port 135, network connection 122, network fabric 120, network connection 116, and host port 115. Method 300 ends.

In an alternative example, host n 110 issues a read request to storage controller 1 130 via host port 115, network fabric 120, network connection 122, and SC port 135. Storage controller 1 130 reads the requested data from storage element n 160. Distributed control entity 150 determines that SC port 145 is the optimal response data path and configures SC port 145 to spoof SC port 135. Storage controller 1 130 forwards the status and data to storage controller n 140 via interconnect data path 155, which forwards the data and status to host n 110 via SC port 145, network connection 124, network fabric 120, and host port 115.

While the invention has been described in detail in connection with the exemplary embodiment, it should be understood that the invention is not limited to the above disclosed embodiment. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

1. A method for servicing an I/O request by a host directed to a particular storage element of a plurality of storage elements coupled to a plurality of storage controllers, the method comprising:
receiving said I/O request at a first port of a first storage controller;
determining which one of said plurality of storage controllers is associated with the storage element to which the I/O request is directed;
forwarding said I/O request from said first storage controller to a second storage controller which has been determined to be associated with the storage element to which the I/O request is directed;
at said second storage controller,
conducting a transaction, or causing another one of said plurality of storage controllers to conduct the transaction on behalf of said second storage controller, with said particular storage element, said transaction being consistent with said I/O request, and
sending a message to signal a completed status of said transaction to said host, said message being sent from a port located on said second controller and said message identifying itself as being sent from said first port of said first controller.

2. The method of claim 1, wherein said I/O request is a read request and said message includes data read from said particular storage element.

3. The method of claim 2, wherein said message is sent over a network via a status frame and a data frame.

4. The method of claim 3, wherein said status frame and said data frame are identified as originating from said first port of said first storage controller.

5. The method of claim 1, wherein said message is sent via at least one network frame and said network frame is identified as originating from said first port of said first controller.

6. The method of claim 1, wherein said step of determining comprises selecting, as said second storage controller, an optimal storage controller from said plurality of storage controllers based upon a criteria.

7. The method of claim 6, wherein said criteria comprises the network bandwidth utilized by at least some of said plurality of storage controllers.

8. The method of claim 6, wherein said criteria comprises the port throughput of at least some of said plurality of storage controllers.

9. The method of claim 6, wherein said criteria comprises load balancing among at least some of said plurality of storage controllers.

10. The method of claim 6, wherein said criteria comprises storage controller to storage element association.

11. A method for servicing an I/O request by a host directed to a particular storage element of a plurality of storage elements coupled to a plurality of storage controllers, the method comprising:
receiving said 1/O request at a first storage controller;
servicing said I/O request;
determining which one of said storage controllers is associated with the storage element to which the I/O request is directed;
at said second storage controller,
sending a message including a completion status of said I/O request, said message being spoofed by said second storage controller to appear to the host as having been originated by said first storage controller.

12. The method of claim 11, wherein said I/O request is received at a port of said first storage controller and said spoofing comprises making said message appear to have originated at said port of said first storage controller.

13. The method of claim 11, wherein said second storage controller is an optimal storage controller for sending said message to said host.

14. The method of claim 13, wherein said second storage controller is determined using a criteria.

15. The method of claim 14, wherein said criteria comprises the network bandwidth utilized by at least some of said plurality of storage controllers.

16. The method of claim 14, wherein said criteria comprises the port throughput of at least some of said plurality of storage controllers.

17. The method of claim 14, wherein said criteria comprises load balancing among at least some of said plurality of storage controllers.

18. The method of claim 14, wherein said criteria comprises storage controller to storage element association.

19. A storage system, comprising:
a plurality of storage controllers, each of said storage controllers including at least one host port for coupling to one or more hosts and at least one storage port for coupling to one or more storage elements;
an interconnect coupling said plurality of storage controllers; and
a control entity, coupled to each of said storage controllers;
wherein when an I/O request is received from a host on a host port of a first one of said plurality of storage controllers,
one of said plurality of storage controllers conducts a transaction with a storage element consistent with said I/O request, and
said control entity causes a second one of said plurality of controllers to send a message including a completion status regarding said transaction to said host, and
said message is spoofed by said second one of said plurality of controllers to appear to said host as having been originated from said first one of said plurality of storage controllers.

20. The storage system of claim 19, wherein said control entity selects an optimal storage controller from said plurality of storage controllers as said second storage controller based upon a criteria.

21. The storage system of claim 20, wherein said criteria comprises the network bandwidth of a network coupled to said host port utilized by at least some of said plurality of storage controllers

22. The storage system of claim 20, wherein said criteria comprises the host port throughputs of at least some of said plurality of storage controllers.

23. The storage system of claim 20, wherein said criteria comprises the storage port throughputs of at least some of said plurality of storage controllers.

24. The storage system of claim 20, wherein said criteria comprises load balancing among at least some of said plurality of storage controllers.

25. The storage system of claim 20, wherein said criteria comprises storage controller to storage element association.

26. The storage system of claim 19, wherein at least one host port of one of said plurality of storage controllers couples to a host via a network.

27. The storage system of claim 19, wherein at least one storage port of one of said plurality of storage controllers couples to a storage element via a storage bus.

28. The storage system of claim 19, wherein said control entity is distributed among at least two of said plurality of storage controllers.
